(19) United States
(12) Patent Application Publication
(10) Pub. No.: US 2021/0229343 A1
(43) Pub. Date: Jul. 29, 2021

(54) APPARATUS FOR WRAPPING CABLE

(71) Applicant: CERTOPLAST TECHNISCHE KLEBEBÄNDER GMBH, Wuppertal (DE)

(72) Inventors: Samer GHARIBE, Wuppertal (DE); Rene RAMBUSCH, Wuppertal (DE); Timo LEERMANN, Wuppertal (DE)

(21) Appl. No.: 16/769,021

(22) PCT Filed: Nov. 22, 2018
(86) PCT No.: PCT/EP2018/082274

§ 371 Date: Jun. 2, 2020

(30) Foreign Application Priority Data
Dec. 20, 2017 (DE) 20 2017 107 757.8

(51) Int. Cl. B29C 64/118; B33Y 70/00; B33Y 10/00; B33Y 30/00; H01B 13/24; H01B 13/22

(52) U.S. Cl. CPC B29C 64/118; B33Y 70/00; B33Y 10/00; B29K 2033/04; H01B 13/24; H01B 13/228; B33Y 30/00

(57) ABSTRACT

The invention relates to a device for manufacturing a sheath (1) for electrical cables (2), in particular a sheath (1) for cables (2) in automobiles, comprising at least one manipulator (9) and a nozzle (10) connected to the manipulator (9) for dispensing a curable liquid plastic material in the course of a generative manufacturing method. The plastic material comprises a radiation-crosslinkable, acrylate-based polymer as the main constituent.

The invention relates to an apparatus for wrapping cables, in particular a sheath for cables in automobiles, comprising at least one manipulator and a nozzle connected to the manipulator for dispensing a curable liquid plastic material in the course of a generative manufacturing method.

In general, the sheath of electrical cables in automobiles primarily serves to combine the cables in question into a cable bundle or harness. So far, specially designed adhesive tapes have been used in practice. At the same time, the sheath provides mechanical protection for the individual cables or the cable harness or bundle. Due to the specific application, the sheath must be flexible, for example in order to be able to follow a curved shape of a cable harness produced in this way inside an automobile. In addition, in particular when laying the cable harness in question in the engine compartment, specific requirements with regard to the temperatures prevailing there and also with regard to any resistance to media such as gasoline and oil must be met.

Mainly, oil and gasoline resistance is required for such sheaths. In addition, such sheaths must of course be designed to be electrically insulating. Furthermore, a temperature stability is sought that corresponds, for example, to a minimum continuous use temperature of minus 40° C. and a maximum continuous use temperature of 100° C. with a stress duration of 3000 hours.

In this case, the sheath is grouped into the associated temperature class B in accordance with standard LV 312 (10/2009).

Although this standard classifies adhesive tapes with regard to their properties for applications in the automotive industry, preferably for bundling and wrapping wires and line sets, it is also generally practical for sheaths that are intended to replace such adhesive tapes.

In addition, this standard distinguishes between determined abrasion resistance and noise reduction classes that are relevant and essential for the adhesive tapes in question. An overview of the norm in question and the corresponding criteria is presented, for example, in utility model DE 20 2014 106 247, to which express reference is made.

In practice, the adhesive tapes mentioned are typically wound in a spiral or helical shape around the individual cables in order to form the desired cable bundle and, in the end, to produce the desired cable harnesses in motor vehicles. This is complex and currently it can practically only be done by hand, especially since the number of cable harnesses used in practice is almost unmanageable due to the variety of models of motor vehicles. Similar problems arise in the event that as a sheath a hose sheath is used through an envelope of a piece of hose formed running in the axial direction.

The previous procedures and those used in practice are associated with the serious disadvantage that all types of wrapping of the individual cables for the production of cable harnesses in motor vehicles or automobiles are made manually. Practically every cable harness is in fact unique, so that it has so far not been possible to manufacture them with machine support.

In the generic state of the art according to DE 10 2014 216 761 [U.S. Pat. No. 10,068,680], attempts are already being made to attach a sheath that can be applied thereto or thereon by machine when manufacturing a cable set. For this purpose, the respective cable bundle is equipped with a bundling element. The bundling element is a textile-like fiber interlacing that is produced as a liquid plastic material by applying a suspension comprising fibers and binders to the cable bundle. The liquid plastic material can then be dried to evaporate the solvent so that the textile-like fiber interlacing is formed from the suspension.

In the scope of the known method according to DE 10 2014 217[6] 761, the suspension can be sprayed onto the combined wires, and the band-like bundling element formed in this way is guided helically around the combined wires. In this context, repeated application of the suspension alternating with drying phases or subsequent treatments is also conceivable, so that an overall generative manufacturing method can also be implemented as a result.

The prior art has proven itself in principle, but reaches its limits due to the textile-like fiber interlacing on the surface. The overall structure of the fiber interlacing should be similar to that of a fleece, but at the same time it should be comparable to that of a woven textile in terms of tear strength. Ultimately, this is attributed to the additional binder present in the suspension. However, the proportion by weight of the binder can only be set relatively low in order nevertheless to ensure the flowability of the known suspension that is necessary for processing. In practice, this results in strength problems. In addition, it cannot be guaranteed overall that the sheath produced in this way has a substantially continuous layer thickness, so that overall either the cable set produced in this way does not have the necessary flexibility for its subsequent laying or the cables or wires are not perfectly combined. In addition, such sheaths are (must) often be colored nowadays, for example to identify the cable harnesses equipped with them.

For example, in connection with electric cars, one knows the requirement that high-voltage cables are marked in orange. Of course, other colorations besides a typically used black coloring are often required. This is usually achieved by adding color pigments to the plastic material that in the known teaching leads to a weakening or at least to an uneven distribution due to the suspension used, especially since the fibers used cannot usually be dyed or must be colored in advance, increasing the work. The invention as a whole aims to remedy this.

The object of the invention is further develop such an apparatus in such a way that a homogeneous sheath of great flexibility is made and at the same time there is the possibility of easy coloring.

To attain this object, a generic cable-wrapping apparatus and in particular a sheath for cables in automobiles is characterized in the scope of the invention in that the plastic material has a radiation-crosslinkable, acrylate-based polymer as its main constituent.

Radiation crosslinking of the polymer can in principle take place with the aid of electro-magnetic beams or electron beams. Most of the time, the radiation-crosslinkable polymer is crosslinked with the help of UV rays. In addition, the plastic material as a whole can advantageously be extruded, that is to say it is formed to be extrudable.

Consequently, within the scope of the invention, initially no suspension is used expressly, but rather the desired sheath for the cables is constructed from a liquid plastic material that as a rule extrudes and cures or is designed to be curable by the action of, in particular, electromagnetic rays. The curing advantageously takes place physically, namely by crosslinking with UV rays, and consequently UV crosslinking. By using an initially liquid and then curable plastic material with a radiation-cross-linkable, acrylate-based polymer as the main constituent, the sheath can be manufactured homogeneously and easily. This means that the radiation-crosslinkable acrylate-based polymer is present in the plastic material to more than 50% by weight.

In this way, color pigments can be added to the plastic material without any problems and without fear of inhomogeneities. As a result, a UV-crosslinkable, acrylate-based polymer and in particular a UV-crosslinkable acrylate rubber is advantageously used as the main constituent of the plastic material that is used to build up the sheath for electrical cables with the aid of the described apparatus.

The radiation-crosslinkable polymer used according to the invention is advantageously a grafted acrylate polymer. The grafted acrylate polymer is equipped with side branches that are connected to an existing polymer chain or a polymer backbone as a backbone. In fact, according to the invention, the grafted acrylate polymer has hydroxy, carboxyl or epoxy-functionalized acrylate monomers that are functionalized by grafting. The described grafting gives the acrylate polymer the desired acrylate functionality, so that the crosslinking and in particular UV crosslinking of the individual polymer chains can then take place with one another. This results in acrylate derivatives.

The proportion by weight of the hydroxyl, carboxyl or epoxy groups is up to 10% by weight, based on the acrylate polymer. In addition, the acrylate polymer is usually equipped with a molecular weight between 40,000 and 100,000. The acrylate polymer can in turn consist of a monomer that is selected from the group comprising, for example, iso-octyl acrylate, methyl acrylate, ethyl acrylate and vinyl acetate and combinations.

In addition to the radiation-crosslinkable acrylate-based polymer, the plastic material is equipped with a photoinitiator, fillers, dyes and, where appropriate, a crosslinker. With the help of the photoinitiator, the crosslinking reaction of the individual polymer chains, in particular when irradiated with UV radiation, and thus the curing of the plastic material as a whole, is realized.

With regard to the photoinitiator and optionally the crosslinker, the invention recommends that these are present and used in the plastic material at 0.01 to 10 parts per 100 parts of the radiation-crosslinked polymer. Benzyl dimethyl ketal photoinitiator, for example, can be used as a suitable photoinitiator and in particular UV photoinitiator, which of course is in no way restrictive.

The filler and optionally the dye are in turn contained to 0.1 to 60 parts per 100 parts of the radiation-crosslinkable polymer in the plastic material. This means that the radiation-crosslinkable polymer continues to be the main constituent in the plastic material with more than 50% by weight, the filler and optionally the dye also being able to take up a significant proportion as described.

The physical crosslinking or UV crosslinking of the liquid plastic material or the radiation-crosslinkable acrylate-based polymer that contains the main constituent by weight, is generally carried out with the aid of a treatment unit formed as a UV radiator. The UV radiator typically emits in a wavelength range between 200 nm and 600 nm, preferably between 300 nm and 400 nm.

In this context, it has proven particularly useful if at least one LED or UV-LED is used as the UV radiator. Most often one works with a plurality of UV-LEDs that are arranged in a matrix. The radiation dose emitted by the UV radiator used is typically in the range from more than 20 mJ/cm² to approximately 800 mJ/cm², in particular up to approximately 400 mJ/cm².

Finally, for example, one color pigment or a plurality of color pigments can also be added to the plastic material. An amount of up to 50 parts per 100 parts of the radiation-crosslinked polymer has proven to be particularly favorable here. Since the color pigments are isotropically distributed in the liquid plastic material, an overall homogeneous and problem-free coloring can be expected.

As a result, an apparatus is provided that directly molds the desired flexible hose sheath for bundling cables, in particular in automobiles, onto the cable, using the generative manufacturing method. This means that the sheath in question is built up layer by layer using the generative manufacturing method. In this context, each layer corresponds to a three-dimensional spatial curve, the extent and position of which in space is predetermined by a computer or a controller that acts on the manipulator and the nozzle connected to the manipulator.

After the layer in question has been built up, the layer and consequently the sheath is cured, namely physically and preferably by UV crosslinking. For this purpose, the layer in question is applied with the aid of the treatment unit formed as a UV radiator.

In all of this, production is particularly easy and quick because the radiation-crosslinkable polymers contained in the plastic material, like the plastic material as a whole, can be processed without problems in the heated state by extrusion or application with the nozzle. The plastic material leaves the nozzle in molten form and is then cured by crosslinking. After the plastic in question and consequently the layer has cured, the desired sheath can be built up step by step and is available immediately after the generative manufacturing method has been completed. This means that in this way cable harnesses or cable harnesses can be realized in practically any shape and form, in a mechanical way and without manual winding processes of adhesive tapes. This is where the main advantages can be seen.

The invention is explained in more detail below with reference to a drawing that only shows one embodiment; in which:

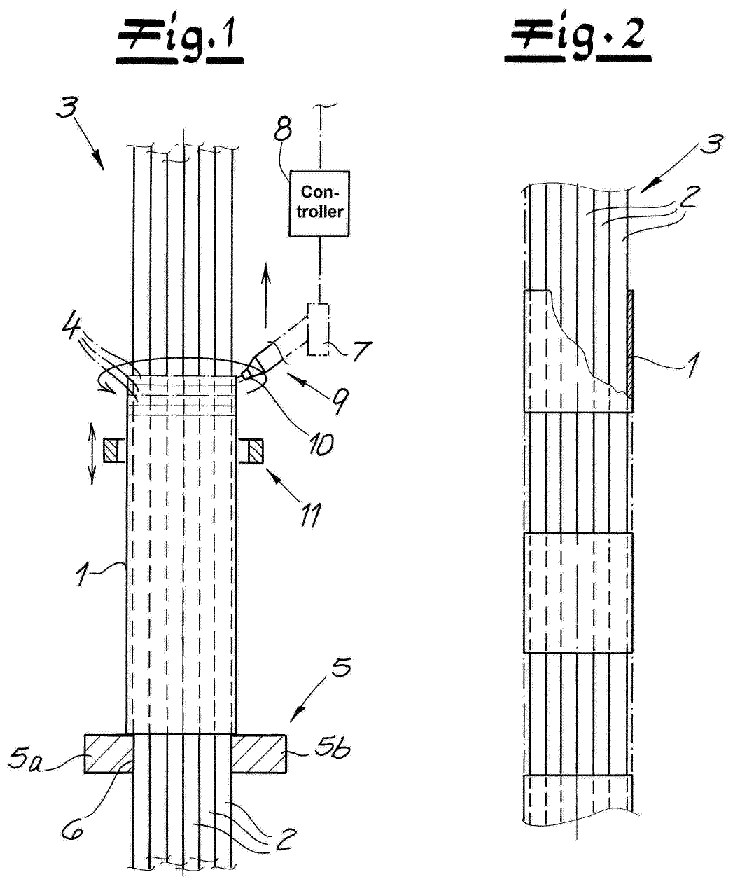

FIG. 1 shows an apparatus for making a sheath for electrical cables or for group cables in automobiles to form a cable bundle,

FIG. 2 shows the cable bundle produced in this way in a side view, partially in section,

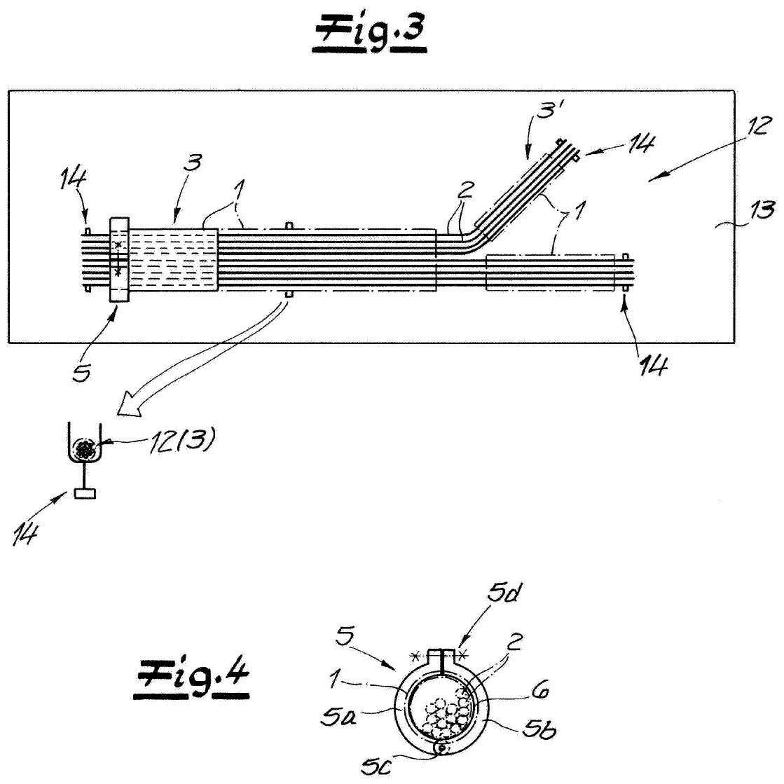

FIG. 3 shows the cable bundle as a constituent of a cable harness assembled on a form board, and

FIG. 4 shows the base for the construction of the flexible hose sheath in detail.

In the drawing, an apparatus for making a sheath 1 for electrical cables 2 is shown. The sheath 1 can cover the cables 2 in question alone their entire axial length. This is indicated by dot-dash lines in FIG. 2. In addition, however, there are also embodiments within the scope of the invention in which the sheath ensures that only sections of the cables 2 are wrapped. The solid lines in FIG. 2 illustrate this. In this embodiment, the cables 2 are electrical cables as constituents of a cable harness 3 formed in this way. The cable harness 3 including the sheath 1 is designed in the illustrations as a constituent of a cable harness 12 for electrical wiring within an automobile.

The cable harness 12 is shown in detail in FIG. 3. In order to assemble the cable harness 12 and also to attach the sheath 1 of the individual cables 2, the cable harness 12 in question is received and held on a so-called form board 13 in this embodiment. Such form boards 13 are generally known in the prior art, for which reference is made to DE 10 2011 084 786. Individual holders 14 or spacers 14 can be provided to hold the cable harness 12 on the form board 13.

The sheath 1 is now produced according to the invention in whole or in part with the aid of a generative manufacturing method by building up a predetermined layer sequence, as is indicated in detail in FIG. 1. In fact, one can see in FIG. 1 a sheath 1 formed as a flexible hose in detail, which completely or partially envelops the cables 2 in their longitudinal direction. With the help of the flexible hose sheath 1, the cables 2 are bundled into the cable harness 3. The cable harness 12 is then constructed from the individual cable harnesses 3 for installation in the automobile (not shown in more detail).

The generative manufacturing method implemented within the scope of the invention is characterized in that the sheath or the flexible hose sheath 1 is realized by individual layers 4 that, in the embodiment according to FIG. 1, are built up one above the other and adjoin one another, so that the more or less cylindrical flexible hose sheath 1 is produced in this way from the individual annular layers 4. The layers 4 consequently form the layer sequence that is molded onto the cables 2 using the generative manufacturing method.

It can be seen in the scope of the illustration as shown in FIG. 1 that the flexible hose sheath 1 envelops the cables 2 or the cable harness 3 combined in this way within a short distance. This means that the flexible hose sheath 1 lies on the outside at a distance from the cable harness 3 and also ensures that the cables 2 are mutually fixed in order to bundle them into the cable harness 3. The hose sheath 1 can in turn be secured axially using, for example, an adhesive tape or other fastening means on the cable harness 3. Basically, for example, a branch 3′ of the cable harness 3, as shown in FIG. 3, or other elements also ensure axial securing of the flexible hose sheath 1.

The hose sheath 1 can be applied directly and in layers to the cable harness 3, but this is not shown. In fact, the individual layers 4 of the flexible hose sheath 1 can be spirally guided around the cable harness 3 at an angle to the longitudinal extent of the cable harness 3. In this case, the individual layers 4 in turn define a largely cylindrical body, but in such a way that the individual layers 4 are helically guided as turns around the cable harness 3 and at least partially overlap. Overall, this is not shown.

Within the scope of the embodiment, the layers 4 and the layer sequence realized therefrom are constructed in such a way that the individual layers 4 are uniformly stacked one upon the other, and thereby shape and define the overall cylindrical flexible hose sheath 1. For this purpose, the hose sheath 1 in question is built up on a base 5. In the embodiment, the base 5 is a disk with a central opening 6 for the cable harness 3 guided thereby. In the present case, the base 5 and the cable harness 3 are stationary. Basically, the base 5 can also rotate. Relative movement between the base 5 and the cable harness 3 is also possible.

The detailed structure of the base 5 can be seen from FIG. 4. Here one can see that the base 5 is constructed in multiple parts and can be taken apart. In the embodiment and not by way of limitation, the base 5 is composed of two semicircular half-shells 5a, 5b that are coupled to one another via a hinge joint 5c. An additional closure 5d ensures that the two half-shells 5a, 5b fitted around the cable harness 3 or the individual cables 2 are secured to one another in the installed state. With the aid of the base 5 that can be spread in this way, the cable harness 3 can be enclosed by the base 5, even when fixed on the form board 13 as shown in FIG. 3.

All that is necessary is to align the form board 13 accordingly relative to a nozzle 10 or a manipulator 9 that will be described in more detail below. In fact, one will usually proceed in such a way that the form board 13 or generally a holder 13 for the cable harness 12 on the one hand and the nozzle 10 on the other hand can each be moved spatially independently of one another. In principle, however, it is also possible to work in such a way that either only the form board or the holder 13 or only the nozzle 10 is movable.

In this embodiment, the base 5 and the cable harness 3 are each stationary. The same may apply to the form board 13. The cable harness 3 with its cables 2 to be bundled is passed through the opening 6 in the base 5. FIG. 1 shows a drive 7 that acts on the manipulator 9 already mentioned. For this purpose, a controller 8 is provided that operates on the drive 7 or the manipulator 9. With the aid of the drive 7, the manipulator 9 can be moved in the axial direction indicated in FIG. 1, so that the layer sequence built up there on the base 5 can be traced. In addition, the manipulator 9 ensures that the connected nozzle 10 performs the circular movements or arc movements indicated in FIG. 1 in order to implement the layer sequence. The manipulator 9 may be a robot or robot arm that can carry out three-dimensional movements overall.

A shapeless liquid material in the form of a liquid plastic, according to the embodiment of a plastic material with a radiation-crosslinkable acrylate-based polymer, is dispensed via the nozzle 10 as the main constituent. The plastic material is liquid and curable. This is primarily ensured by the radiation-crosslinkable acrylate-based polymer as the main constituent, as has already been described above. For this purpose, the liquid plastic material contains, in addition to the radiation-crosslinkable acrylate-based polymer, not only a UV crosslinking agent or a photoinitiator, but optionally also color pigments in the weight compositions specified above.

For the construction of the sheath 1, a first layer 4 is first built up on the base 5 by the manipulator 9, controlled by the controller 8, executing a circular movement shown in FIG. 1 and merely indicated, around the cable harness 3 passed through the opening 6. After the first layer 4 has cured, the manipulator 9 applies a further second layer 4 to the first layer 4 with the nozzle 10, so that in the end the layer sequence that was already described and defines the cylindrical flexible hose sheath 1, is built up on the base 5, in that the layer sequence or the hose sheath 1 surrounds the opening 6 with the cable harness 3 passed through it.

The hose sheath 1 is consequently built up on the base 5. Starting from the base 5, the hose sheath 1 wraps around the cable harness 3. The individual layers 4 of the layer sequence and consequently the flexible hose sheath 1 are produced on the base 5 with an assembly speed of up to 100 mm/s at an achievable layer height. A treatment unit 11 is provided in order to cure the plastic material used at this point and dispensed in fluent form via nozzles 10. In the embodiment, the treatment unit 11 can be moved back and forth at least axially along the cable harness 3, as indicated by a double arrow in FIG. 1. In this way, the treatment unit 11 can be used and serve for the physical treatment of the layer sequence or the respective layer 4.

The treatment unit 11 is one that is used for the physical solidification of the individual layers 4 or the flexible hose sheath 1 formed in this way. In fact, the treatment unit 11 in the embodiment is one that optically ensures that the plastic material is cross-linked. By crosslinking the relevant layer 4 with the aid of the treatment unit 11 or the UV radiator realized at this point, the layer 4 is cured step by step. Finally, the base 5 can then be removed and the flexible hose sheath 1 is secured at the desired location on the cable harness 3.

1. An apparatus for making a sheath for electrical cables, the apparatus comprising:
a manipulator;
a nozzle connected to the manipulator for dispensing a curable liquid plastic material in the course of a generative manufacturing method, the plastic material having a radiation-crosslinkable, acrylate-based polymer as the main constituent.

2. The apparatus according to claim 1, wherein the radiation-crosslinkable polymer is a grafted acrylate polymer.

3. The apparatus according to claim 2, wherein the grafted acrylate polymer contains hydroxy-, carboxyl- or epoxy-functionalized acrylate monomers that are functionalized by grafting.

4. The apparatus according to claim 1, wherein the plastic material in addition to the radiation-crosslinkable polymer has a photoinitiator, fillers, and dyes.

5. The apparatus according to claim 4, wherein the photoinitiator is contained in the plastic material in an amount of 0.01 to 10 parts per 100 parts of the radiation-cross-linkable polymer.

6. The apparatus according to claim 4, wherein the filler is contained to 0.1 to 60 parts per 100 parts of the radiation-crosslinkable polymer in the plastic material.

7. The apparatus according to claim 1, wherein the plastic material is physically solidified using a treatment unit formed as a UV radiator.

8. The apparatus according to claim 7, wherein the UV radiator emits in a wavelength range between 200 nm to 600 nm.

9. The apparatus according to either claim 7, wherein the UV radiator has a LED.

10. The apparatus according to in that claim 7, wherein the radiator is a UV generator that generates a radiation dose of more than 20 mJ/cm² up to about 800 mJ/cm².

11. A method of making a sheath for electrical cables, the method comprising:
supplying to a nozzle a fluent and curable plastic material having a radiation-crosslinkable, acrylate based polymer as its main constituent;
extruding from the nozzle around the electrical cables a strand of the plastic material to form therearound a tube of the plastic material; and
curing and hardening the plastic material of the tube into the sheath.
